(19) United States
(12) Patent Application Publication
(10) Pub. No.: US 2018/0002234 A1
(43) Pub. Date: Jan. 4, 2018

(54) Method of manufacturing micronized sandstone obtained from ceramics or industrial wastes of ceramic manufacturing containing TiO2 bio-additive, and product thereof

(71) Applicant: ANGELO GASSI, Rio de Janeiro (BR)

(72) Inventor: ANGELO GASSI, Rio de Janeiro (BR)

(21) Appl. No.: 15/311,274

(22) PCT Filed: Jul. 3, 2016
(86) PCT No.: PCT/BR2014/000219

§ 371 Date: Nov. 15, 2016

(51) Int. Cl. C04B 33/132; B01J 21/16; B01J 35/00; B01J 37/04; B01J 37/00; C04B 33/30; B01J 21/06; C04B 33/13; B01J 35/02

(52) U.S. Cl. CPC C04B 33/1324; C04B 33/131; B01J 21/16; B01J 35/004; B01J 35/02; B01J 37/0018; C04B 33/30; C04B 33/1321; B01J 21/063; B01J 37/04; B01J 37/0036; C04B 2235/3232; C04B 2235/349; C04B 2235/5436; C04B 2235/606; C04B 2235/963

(57) ABSTRACT

The present invention discloses a method of manufacturing micronized sandstone obtained from ceramics or industrial wastes of ceramic manufacturing, such as white paste, natural stones or clinker, including TiO₂ as bio-additive, and product obtained by the micronized sandstone thereof. The ceramics and industrial wastes of ceramic are grinded in several steps and the resultant powders are collected by means of individual filters and further combined in a nanopowder micronizer for posterior treatment, where TiO₂ hydrolyzed can be optionally added. This micronized sandstone comprising the bio-additive TiO₂ is used in the production of plasters, mortars, grouts and/or as additive for paints and/or epoxy enriched with TiO₂. The micronized sandstone bio-additive with TiO₂ can be additionally subjected to two optional embodiments of the invention: treatment with or without the use of a pigment. In order to obtain the final product that can be used in the production of blocks, floors and other products of various sizes, an agglomerating agent combined with TiO₂ is added to the micronized sandstone comprising the bio-additive TiO₂, either in an aqueous solution or as a dry product, optionally including colored oxides.

### FIELD OF THE INVENTION

The present application refers to the fabrication process of micronized sandstone obtained from industrial waste of ceramics manufacturing, such as ceramic white paste natural stones or clinker, treated with TiO₂ hydrolyzed or not, and product obtained by the micronized sandstone thereof.

### BACKGROUND OF THE INVENTION

Problems with the environment are increasing everyday due to the unsystematic use of natural resources, as well as the generation and disposal of construction industry solid waste. The large volume of debris produced and discarded by the placement and replacement of ceramic materials are enormous (about 500 million cubic meters/year) and they are improperly managed or thrown into landfields, which block the drains culverts, thus causing floods and subsequent proliferation of diseases.

Therefore, it becomes necessary to recycle and reutilize the ceramics and solid wastes as raw material for construction, in order to control and minimize environmental impacts.

It is known from the state of the art, several patents disclosing different technologies, which attempts to reduce the ceramic industry cost and minimize the environmental impact. One example is the utility patent BRMU8903002-8 which describes a process for production of ceramic plates for floors and coverings, comprising the addition of ash sugarcane bagasse ash as flux material in the formulation, wherein the sugar cane bagasse ash is a residue obtained from the sugar cane processing.

Another example is the patent application BRPI 0600081-9 which discloses the production of red ceramic made of construction machinery wastes such as ferrous slag, sludge, purge and all types of foundry sand, wastes of glass, sodium and natural clay-compositions used in the manufacture of ceramic products that contain in their composition, besides the raw materials commonly employed, also ferrous slag, sludge (or dry mud powder) of exhaustion (thin green sand+bentonite+charcoal) all kinds of foundry sands (green sand, cold box sand, Macharia sand), blasting dust residues (micro glass beads) or other types of vitreous wastes, sodium salts and natural red clay.

Another example is patent application CN101186519 which discloses a porous ceramic material and a preparation process thereof, wherein the invention uses polishing bricks waste and describes an auto mechanism of ceramic foam production.

Patent application AU2014201184 describes materials containing titanium that are able to form high-temperature-resistant and wear resistant titanium compounds, for example, aluminium titanates, magnesium titanates, Ti(C,N) using steel waste (slag).

The applicant also has knowledge of patent EP1834935 which describes an agglomerated stone product obtained by the addition of titanium dioxide particle, preferably as nanosize, in the vibrocompaction phase of the stone material in the presence of resin and cross-linking agents.

Unfortunately, none of the prior art cited above addresses the issue of the use of residual ceramic materials. In contrary, the final product obtained by the processes above described, is not homogeneous and does not meet the required quality standard, nor satisfies the requirements needed for ceramics, because the particle size of the raw materials interferes in various properties such as plasticity, sintering rates, final porosity, density, structural compression, mechanical strength, porosity, resistance to chemical attack, abrasion (hardness), antifreeze property, resistance to stains, etc.

In addition, the use of ceramic waste as raw material in the construction of new floors, terraces, walls, etc., is very important to eliminate any kind of organic matters that can generate mildew, lichens, fungi, bacteria etc. on the new surface. This is of particular interest in the areas where strict hygiene is required (hospitals, schools etc.) and in indoor and outdoor areas exposed to large amounts of moisture, such as vicinity of swimming pools, showers, changing rooms, and similar facilities.

Several technologies have been developed in the area of new materials, which applies TiO2 coatings on the surfaces due to their photoactivity, which is a promising feature of them in the use of environments that require the control of microorganisms.

However, some technologies do not work properly when using heating and/or high temperatures to consolidate the coating and they result in cracks, bubbles, rough surfaces, etc. Other technologies use nanoparticles of TiO₂ that are dangerous for human beings and can cause respiratory diseases, cancer, etc. Examples of these technologies can be found in the prior art CN1443605, U.S. Pat. No. 6,210,779, CN102561627 and CN1304336 among others.

In order to resolve the problems described above, the present invention describes a fabrication process of micronized sandstone obtained from industrial waste of ceramics manufacturing, such as ceramic white paste natural stones or clinker, treated with TiO₂ hydrolyzed or not, and product obtained by the micronized sandstone thereof.

### SUMMARY OF INVENTION

The present invention refers to a process of manufacturing micronized sandstone obtained from industrial waste of ceramics manufacturing, such as white paste, natural stones, or clinker, treated with TiO₂ hydrolyzed and thus produced article.

Ceramics or ceramic wastes are crushed in several steps and the resulting powders are collected by individual filters and then combined in the powder nano-micronizer device for subsequent treatment, in which hydrolyzed TiO₂ may be added or not.

The micronized sandstone bio-treated with TiO₂ is used in the production of plasters, mortars, grouts, and/or as additives for paints and/or epoxy micronized additive with TiO₂.

The micronized sandstone bio-treated with TiO₂ may be submitted to two additional embodiments of the process: treatment with or without the use of pigments.

In order to obtain the final article that can be used in the production of blocks, floors and other products of different sizes and dimensions, it is added to the micronized sandstone treated with TiO₂ a binder, also comprising a TiO₂ additive, which is mixed in aqueous solution or dry, with the addition of colored oxides, if desired.

The process is carried out at room temperature and use particulate material obtained from ceramics or industrial waste of ceramic manufacturing.

### Definitions

Unless define otherwise, all technical and scientific terms herein used have the same meaning as generally understood by one skilled in the art to which this invention belongs.
Ceramic masses—are usually composed of clays, kaolin and material, wherein clays give plasticity to the ceramic masses, the kaolin assist on the whiteness of the final product and the alumino-silicates provide what is necessary for the sintering process. Material fluxes, such as feldspar, are used when it is necessary to achieve a higher degree of vitrification in ceramics of the type: sandstone porcelain, china porcelain, porcelain in a single fire semi-vitreous process.

An illustrative example of a typical composition of materials is showed below:

### Chemical Composition (% Weight)

| | | | Sodium | Potassic |
|---|---|---|---|---|
| Oxide | Kaolin | Quartz | Feldspar | Feldspar |
| SiO₂ | 47 | 99 | 72 | 66 |
| Al₂O₃ | 38 | 0.70 | 17 | 18 |
| Fe₂O₃ | 0.39 | 0.04 | 0.05 | 0.04 |
| TiO₂ | 0.03 | — | 0.08 | 0.04 |
| CaO | 0.10 | 0.05 | 0.02 | 0.03 |
| MgO | 0.22 | 0.05 | 0.10 | 0.02 |
| Na₂O | 0.81 | — | 9.5 | 0.08 |
| K₂O | 0.15 | — | 0.30 | 14.7 |
| Fire loss | 13.0 | 0.21 | 0.20 | 0.09 |

Sandstone—it is a material made from fine grained clay, sedimentary and refractory plastic that supports high temperatures, such as ceramics. It glazes between 1150° C.-1300° C. The clays used in their composition are not as pure as the white porcelain, which enables a range of colors. After burning they become waterproof.
Sandstone porcelain stoneware—is also known as porcelain stoneware, ceramic granite, or fine porcelain stoneware. This nomenclature is due to the fact that porcelain stoneware tiles derive from “stoneware” styling ceramic materials with compact structure (characterized by a crystalline phase immersed in a glassy matrix), and “porcelain” is the term that refers to the technical characteristics of this product, which is similar to porcelain. Porcelain stoneware then, is a vitrified product that presents, as main feature, an extremely low porosity, showing excellent mechanical and chemical properties, in addition to resistance to chemical agents and cleaning products, and a good resistance to abrasion. It masks the superficial wear that occurs over time and presents chemical and mechanical properties equal or superior to traditional pottery.
Red ceramic material—is used for the manufacture of structural parts such as bricks and tiles.
White ceramic material—is used in the floor, walls etc.
Micronization—is defined as a ultra fine grinding process using windmills with compressed air (air jet mills).The grinding takes place by clashing the particles of the product itself, that when receiving the compressed air energy gain speed of up 500 m/seg. The particles will decrease size by means of the clashing until it reaches the desired sizes.
Micronized sandstone—is the final product obtained by the sandstone micronization.
Binder—it is a material that has the property of agglutinating/agglomerating other materials (aggregates). Binders are classified as:
   Polymeric binders which have reaction due to the polymerization of a matrix; ex: epoxy resin, acrylic resin, glue, bitumen (tar, asphalt).
   Air binders—binders that make air trapped and get hard in contact with the air ex: plaster, lime.
   Hydraulics—binders made of powdery materials (fine powder) which mixed with water form slurry that will be able to harden by natural drying, i.e. they cause a chemical reaction that releases heat; ex. hydraulic lime, Portland cement, etc.
Mortar—homogeneous mixture of aggregate(s) with small granulometry comprising inorganic binder(s) and water, which may or may not contain additives. Photocatalytic mortar is the one that contains in its composition nanoparticles of titanium dioxide as additive.

### BRIEF DESCRIPTION OF THE FIGURES

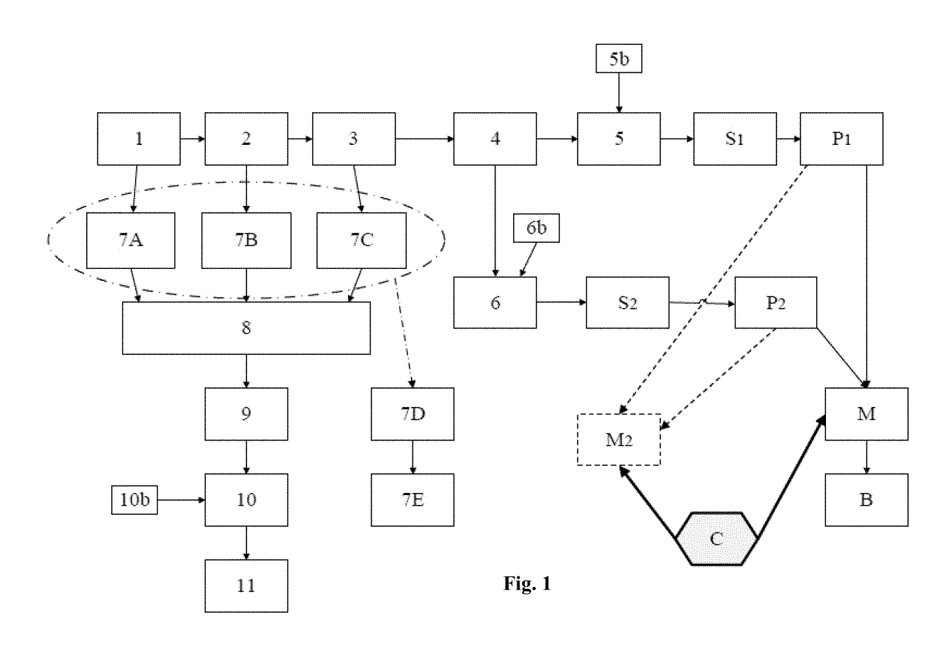

Modalities of this invention will be now described as an illustrative example, referring to the block diagram of FIG. 1.
Numbers (1, 2, 3) represent mills or grinders blocks, wherein the last grinder (3) is a micronized mill.
7A, 7B and 7C blocks represent individual filters for powders and tailings disposal; powder micronizer is represented by (8), the nanomicronized powder is (9) and (10) is the addition of TiO₂ hydrolyzed.
(11) represents the final product for the production of plaster, mortar, grouts, and/or as additive for paints and/or epoxy and/or others. It is the nano micronized powder treated with TiO₂.
The separation of waste is represented by (7D) while recycling is indicated by (7E).

### 1^{st} Embodiment—Treatment Using Pigment

Micronized sandstone raw material (4) comprising particle size ranges from 0 mm to 30 mm
Addition of pigments (5)
Treatment with hydrolytic solution of hydrolyzed TiO₂ (5b)
Drying (S1), thus obtaining a colorful product of micronized sandstone treated with TiO₂ (P1).

### 2^{nd} Embodiment—Treatment Without Using Pigment

Raw material micronized sandstone (4)
Treatment with hydrolitic solution or hydrolyzed with TiO₂ (6)
Drying (S2), thus obtaining a product of micronized sandstone treated with TiO₂ (P2).

### Final Treatment

(M) Mixture of micronized sandstone already treated with TiO₂ with binder additive with TiO₂ and mixed in aqueous solution (with addition of pigments or colored oxides, if desired).
(M2) Mixture of the micronized sandstone already treated with TiO₂, comprising TiO₂ dry binder additive (with addition of pigments or colored oxides, if desired).
C—binder storage of TiO₂ additive (dry)
B—production of blocks, ceramic and floors of variable dimensions or other materials having variable shapes and sizes.

### DETAILED DESCRIPTION OF THE INVENTION

The ceramics or ceramic wastes are crushed in mills/grinders (1,2,3) that break down the raw material in several stages and in specific granulometry, resulting in a micronized sandstone raw material (4), whose particle size ranges from 0 mm to 30 mm. The number of mills and/or crushers is variable, depending on the desired size. The last grinder (3) is a micronized mill. Although in FIG. 1 are represented only 3 mills/grinders, this number should not be limiting.

Grinding powders resulting from this process are collected by the individual filters 7A, 7B and 7C which separate the vitreous materials. Those filters are water-based. As can be seen through FIG. 1, powders resulting from each grinder are retrieved individually, but these will be combined in the nanomicronizer powder (8) for further nano micronization treatment (9).

Hydrolyzed TiO₂ is added to the nanomicronized powder obtained in (9).This final product (11) is used for the production of plaster, mortars, grouts and/or as additives for paint and/or epoxy additive with TiO2. Block 7D represents the separation of waste, which is forwarded to recycling (7E).

The nanomicronized material (4) contains small particles having particle size from 0 mm to 30 mm and that can be used in two additional embodiments of the process: First Embodiment—treatment with the use of pigment and Second Embodiment—treatment without the use of pigment.

### 1^{st} Embodiment—Treatment Using Pigment

In this embodiment, the micronized sandstone raw material (4) is colored with addition of pigments (5) followed by treatment with hydrolytic solution or hydrolyzed TiO₂ (5B) and further drying (S1), thus obtaining a product of colorful micronized ceramic sandstone product treated with TiO₂ (P1).

### 2^{nd} Embodiment—Treatment Without Using Pigment

In this embodiment, the micronized sandstone raw material (4) does not receive pigments, but proceeds to be treated with a hydrolytic solution or hydrolyzed TiO₂ in (6) and further drying (S2), thus obtaining a product of micronized sandstone treated with TiO₂ (P2).

### Final Treatment

In this final step, both P1—the micronized colored sandstone with TiO₂ as P2—the micronized sandstone, already comprising TiO₂ additive are mixed with a binder also comprising with TiO₂ additive, mixed in an aqueous solution (M) or dry (M2), with addition of colored oxides, if desired.

The formation process of the layers can be accomplished through various deposition processes known from the prior art, such as chemical vapor deposition (CVD), physical vapor deposition (PVD), sol-gel and dip-coating processes, this last one, aiming an uniform coating with hydrophilic properties photo induced. The final product (B) is used in the production of blocks, floors, new ceramics and products with variable dimensions.

Unexpected results were achieved by this process using micronized sandstone obtained from ceramics or ceramic manufacturing waste as white paste, natural stones, or clinker, treating these materials with TiO₂ hydrolytic, because the crystalline structure of the ceramics or their residues are formed by a three dimensional network of extended crystals, similar to pores.

Therefore, when the micronized sandstone is immersed in the hydrolytic TiO₂ solution, the interstices and the crystalline lattice of the material are impregnated, forming not only an outer covering, but a dense and compact internal structure.

Several experiments were carried out testing porosity of residual materials used by this invention. We used the standard ABNT/NBR 15097:2004 and their values determined by equation 1:

$$PA ( \% ) = \frac{Pu - Ps}{Pu - Pi} \times 100 \qquad ( 1 )$$

where:
PA is apparent porosity (%);
Pu is the body weight of the damp proof (g);
Ps is the body weight of the dry proof (g);
Pi is the body weight of the immerse proof (g).

It was verified that the apparent porosity of the material decreases with the increasing of the temperature, and this can be explained because of the efficient formation of a liquid phase, in which a lower surface tension and capillary action helps to keep the particles together, retracting the material, thus reducing the porosity.

As a result, the present invention does not use heating or UV or infrared radiations, as described in the prior art, but the process described by the present invention can be performed at room temperature or with heating (100° C./200° C.), which provides a better and more efficient impregnation of the TiO₂ in the sandstone.

The final treatment of P1—micronized sandstone colored with TiO₂ or P2 micronized sandstone treated with TiO₂, with binder aggregated with TiO₂ mixed in an aqueous solution (M) or dry (M2), with addition of colored oxides, if desired, serves to “seal” this impregnated product, thus producing a resistant layer also containing TiO₂.

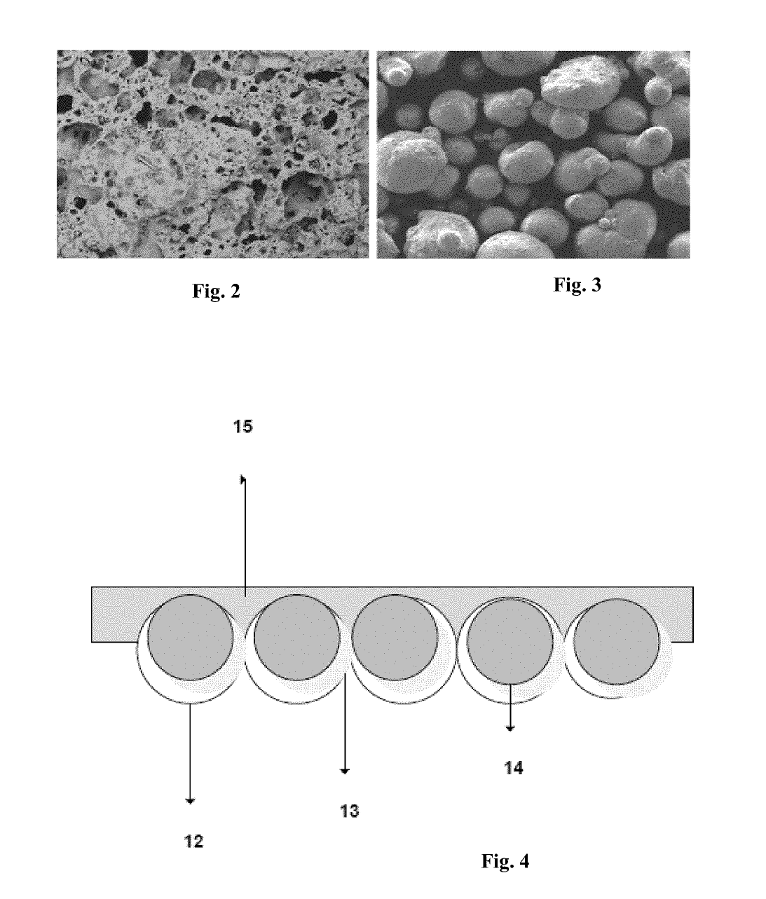

FIG. 2 depicts the structure of the porous ceramic material seen through the microscope showing the crystalline interstices.

FIG. 3 shows the micronized sandstone treated with TiO₂ structure seen through the microscope. It can be noticed the initial integration of TiO₂ in the structures of the micronized sandstone.

FIG. 4 depicts a schematic illustration of an article retrieved from the process hereby described, showing the interstices of the crystalline raw material (sandstone) micronized (12) when impregnated with TiO₂ additive, here represented by the spheres (14), forming a binding with the ceramic material, represented by the shaded form (13). The product finishing is made by applying a coating of TiO₂ additive binder (15) which is added to the treated surface in order to make the sealing.

Several are the advantages of this finished product:
Replacement of various materials currently is use, such as concrete, thus reducing maintenance and cleaning expenses;
Use as floor and/or monolithic floor (without grout) reducing treatment costs which are also expensive, cutting back the use of wax or chemicals products for maintenance, among others.
Fabrication of plastering, mortars, grouts and/or others;
Use as self-cleaning eliminating smog (combination of smog and fog).
Comprises a photocatalytic product (TiO₂), which eliminates mold, bacteria, lichen and fungi, so it can be used in hospitals, schools, restaurants, swimming pools, etc.
Can be used as protection to existing materials.
The micronized powder can be sold as raw material for the construction industry of normal or corrugated tiles, ceramics, inks and/or other applications.

### Chemical Process

Titanium dioxide (TiO₂) is an amphoteric metallic oxide semiconductor, which can crystallize in three polymorphic forms: anatase (tetragonal), rutile (tetragonal) and brookite (orthorhombic), being rutile, the more thermodynamically stable phase. When deposited in a thin film form, the crystalline form of TiO₂ depends on the nature of the raw materials, their composition, method of deposition and heat treatment temperature.

The manufacturing process of micronized sandstone obtained from ceramics or waste of the ceramics industries, such as as white paste, natural stone or clinker, treated with TiO₂ hydrolytic, and article so produced, developed by the present invention utilizes the photocatalytic ability of the titanium dioxide, which is induced by the absorption of photons of ultraviolet radiation from sunlight or appropriate lights (band gap of anatase is 3.2 eV and it is equivalent to a wavelength of 388 nm).

As the photons have energy greater than the energy of the band gap of the material, i.e., sufficient energy to excite electrons in the valence band, then this causes its passage to the conduction band. The absorption of energy withdraws an electron from the valence layer and transfers it to the conduction band. As in the conduction band lays a vacant site, called hole or vacancy, then the electron-hole pair moves across the network of nanocrystals.

Then the titanium dioxide acts as a catalyst, when it comes in contact with the light, wining enough power so that the electron passes by valence to the conduction band, thus enabling its displacement by interstices of material. Upon reaching the surface, this electron participates in reactions with oxygen and water forming hydroxyl radical, nascent oxygen or hydrogen peroxide.

The strong oxidizing power of hydroxyl radical (OH⁻) ions and peroxides (O²⁻) contribute in removing debris, molds, lichens, etc. when start their dissociation, thus contributing to its disintegration. The oxidant effect of TiO₂, when subjected to ultraviolet radiation, reduces the angle of internal friction of water causing the surface of the material to be hydrophilic, which contributes to an increase of the self-cleaning effect.

The vacant space left by the electron in the valence band is actually an entity carrier with a positive electrical charge that, in the same way as the electron can move through the crystal. To reach the surface, it reacts with the oxygen in the TiO₂, where the two hydroxyl radicals are absorbed, and the free energy of the surface increases considerably. This high free energy allows the TiO₂ to completely spread forming a continuous film, which is coated and sealed by aggregating materials (cements, binders, etc.)

This mechanism can be represented by the equation below and starts when a photon with sufficient energy impacts the TiO₂ net forming an electron-hole pair:

TiO2+2hv→2e⁻+2h⁺

where hv represents the photon energy, h being the Plank constant, v the light speed, e⁻ the electron and h⁺ the hole created. If the crystal is large, the electron-hole pair recombines the defects of the system and does not reach the surface of the crystal. If the crystal is too small, there will be no formation of sufficient pairs. If the crystal is of an adequate size, the pair moves on the net and reaches the surface.

In general, nano-sized particles present big surface area and attest to a tendency of high reactivity and, when these are added in cement based materials or binders, a great impact occurs on their properties, both in the fresh as well as hardened states.

### Embodiments

Thus, the micronized sandstone manufacturing process using ceramic or wastes produced from the ceramic industries such as white paste, natural stone, or clinker, treated with TiO2, comprises two embodiments, and can be defined by the following steps:

### 1st Embodiment

a. Grind the ceramics or ceramic waste in a series of grinders/crushers (1-3),
b. Obtain the micronized sandstone (4) passing the ceramic material fragmented into a micronizer.
c. Add colored pigments or oxides (5) to the micronized powder obtained (4).
d. Treat the micronized powder (5) with a solution of TiO₂ (5b),
e. Dry (S1) the micronized sandstone treated with TiO₂ (P1)
f. Mix the product (P1) with activated binders with TiO₂.

### 2nd Embodiment

a. Grind the ceramics or waste of ceramics in a series of grinders/crushers (1-3),
b. Get the micronized sandstone (4) by passing the ceramic material fragmented into the micronizer.
g. Treat the micronized sandstone (4) (No. 4 of the 1st Embodiment, now No. 6 of 2nd Embodiment) with hydrolyzed solution of TiO₂ (6b).
h. Dry (S2) the micronized sandstone treated with TiO₂.
i. Mix the product (P2) with activated binders with TiO₂.

The second embodiment can also include an optional step j with the addition of pigments or colored oxides to the agglomerate product obtained (M2).

Products (P1) or (P2) obtained by the two modalities can be mixed with the binder already comprising TiO₂ additive in dry or in aqueous solution.

The number of mills/grinders in both embodiments is variable, but the last mill/crushed is always a micronizer. The number of filters may or may not be equal to the number of mills/grinders in the two modalities.

In both embodiments, the interstices of crystalline micronized sandstone (12) are filled with TiO₂, which forms a bond with the ceramic material and where the binder treated with TiO₂ makes a sealing with layer interstices crystalline micronized sandstone (12) filled with TiO₂. Both the micronized sandstone treated with TiO₂ colored or not can have a photocatalytic property.

Also in both modalities, one or more layers of binders additive(s) also treated with TiO₂ can be used on the layer of micronized sandstone treated with TiO₂.

Therefore, based on the process herein described, new generations of products and ceramic tiles can be considered as part of a set of architectural elements for external and internal uses, because as it was disclosed, they provide a wide range of surfaces properties and functions without prejudice to the aesthetic qualities, not changing the characteristics of the ceramic materials.

The invention thus described will be apparent that it will vary in several ways. Such variations cannot be regarded as a deviation from the spirit and scope of the application of the invention and all modifications as it would be obvious to a person skilled in the art are intended to be included within the scope of the following claims.

1. Method of manufacturing micronized sandstone obtained from ceramics or industrial waste of ceramics manufacturing containing TiO₂ bio-additive, characterized by comprising the steps of:
a. grinding the ceramics or ceramic waste in several mills/grinders (1, 2, 3),
b. obtaining the micronized sandstone (4) by passing the grinded ceramic material into a micronizer,
c. adding pigments or colored oxides (5) to the micronized powder thereof (4),
d. processing the micronized colored powder (5) with a hydrolyzed solution of TiO₂ (5b),
e. drying (S1) the micronized colored sandstone comprising TiO₂ additive (P1)
f. mixing the obtained product (P1) with an agglomerating agent additive with TiO₂.

2. Method of manufacturing micronized sandstone according to claim 1 characterized by:
a. grinding the ceramics or ceramic waste in several mills/grinders (1,2,3),
b. obtaining the micronized sandstone (4) by passing the grinded ceramic material into a micronizer,
g. treating the micronized sandstone (4,6) with hydrolyzed solution of TiO₂ (6b),
h. drying (S2) the micronized sandstone comprising TiO₂ additive (P2),
i. mixing product (P2) with an agglomerating agent comprising TiO₂.

3. Method of manufacturing micronized sandstone according to claim 2 characterized by optionally adding (j) pigments or oxides to the agglomerated product obtained (M2).

4. Method of manufacturing micronized sandstone, according to claims 1 or 2, characterized that product (P1) or (P2) is mixed with agglomerating agent also comprising TiO₂ additive, hydrolyzed or not.

5. Method of manufacturing micronized sandstone, according to claims 1 or 2, characterized that the micronized sandstone comprising TiO₂ additive, with or without pigments is utilized in the production of blocks and ceramic floors in several sizes and dimensions.

6. Method of manufacturing micronized sandstone, according to claims 1 or 2, characterized that the resulting powders produced by the milling steps (a) are collected by individual filters (7A, 7B e 7C).

7. Method of manufacturing micronized sandstone, according to claim 6 characterized that the powders originated from grinding (a) are combined in the powder micronizer (8) for further nano micronization (9) and additivation with TiO₂ (10), thus producing a nano micronized powder comprising TiO₂ additive (11).

8. Method of manufacturing micronized sandstone, according to claim 7 characterized that the nano micronized powder comprising TiO₂ additive (11) is used in the production of plaster, mortar, grouts and/or additives for paints and/or epoxy enriched with TiO₂.

9. Method of manufacturing micronized sandstone according to claims 1 or 2, characterized that the number of mills/grinders is variable.

10. Method of manufacturing micronized sandstone according to claims 1 or 2, characterized that the last mill/grinder is a micronizer.

11. Method of manufacturing micronized sandstone according to claims 1 or 2, characterized that the nano micronized powder (4) is configured to have a granulometry from 0 mm to 30 mm.

12. Method of manufacturing micronized sandstone according to claim 6, characterized that the number of filters is equal or different from the number of mills/grinders.

13. Method of manufacturing micronized sandstone according to claims 1 or 2, characterized that the crystalline interstices of the micronized sandstone (12) are filled with TiO₂ forming a bond with the ceramic material.

14. Method of manufacturing micronized sandstone according to claims 1 or 2, characterized that the binder with TiO₂ additive seals the layer containing the crystalline interstices of micronized sandstone (12) filled with TiO₂.

15. Method of manufacturing micronized sandstone according to claims 1 or 2, characterized that the micronized sandstone with TiO₂ additive, with or without pigment, has photocatalytic properties.

16. Product manufactured of micronized sandstone produced in accordance with the process of claims 1 or 2, characterized by comprising a layer of micronized sandstone with TiO₂ additive and one of more layers of binders also containing TiO₂ additive.

17. Product manufactured of micronized sandstone according to claim 16, characterized by the fact that the sandstone with TiO₂ additive optionally includes pigments, colored oxides and /or their mixtures in the layers.

18. Product manufactured of micronized sandstone according to claim 15, characterized that the binder is a polymeric, hydraulic or air binder material.

19. Product manufactured of micronized sandstone according to claim 15, characterized that it is used in the production of blocks, ceramic floors in several forms and dimensions, with or without pigments.

20. Product manufactured of micronized sandstone according to claim 15, characterized by presenting photocatalytic and hydrophilic properties.
